(19) United States
(12) Patent Application Publication
(10) Pub. No.: US 2014/0320844 A1
(43) Pub. Date: Oct. 30, 2014

(54) Range Finder

(71) Applicants: Asia Optical International Ltd., Tortola (GB); Sintai Optical (Shenzhen) Co., Ltd., Shenzhen City (CN)

(72) Inventors: Hua-Tang Liu, Taichung (TW); Chin-Hsiang Wang, Taichung (TW)

(73) Assignees: Asia Optical International Ltd., Tortola (GB); Sintai Optical (Shenzhen) Co., Ltd., Shenzhen City (CN)

(21) Appl. No.: 14/147,624

(22) Filed: Jan. 6, 2014

(30) Foreign Application Priority Data
Jan. 14, 2013 (TW) 102101276

(51) Int. Cl. G01C 3/08

(52) U.S. Cl. CPC G01C 3/08
USPC 356/4.01

(57) ABSTRACT

A range finder includes a laser transmitter, an IR transmitter, a laser receiver, an objective lens, an image sensing device, a prism device, and a display device. At least one laser beam is emitted from a laser transmitter and reflected to a laser receiver by a measured object. An infrared ray is emitted from the IR transmitter and reflected to the image sensing device by the measured object. The prism device is disposed between the objective lens and the image sensing device, for guiding visible light and the infrared ray to the image sensing device and guiding the laser beam to the laser receiver. The display device displays the image of the measured object that is captured by the image sensing device.

### BACKGROUND OF THE INVENTION

### 1. Field of the Invention

The invention relates to a range finder, and more particularly to a range finder with a night vision function.

2. Description of the Related Art

A conventional range finder is capable of transmitting a signal to a surface of a measured object, and the signal is reflected from the measured object back to the range finder and received by a receiving device in the range finder. Then, the range finder calculates the traveling time of the signal between the measured object and the range finder so as to obtain the distance of the measured object from the range finder. As the semiconductor laser has been significantly developed recently, laser range finders which transmit laser signals are present. Such laser range finders cannot be utilized at night or in environments of insufficient light and thus cannot satisfy all the users' requirements.

### BRIEF SUMMARY OF THE INVENTION

The invention provides a range finder capable of measuring distance at night or in the environments of insufficient light. The range finder in accordance with an exemplary embodiment of the invention includes a laser transmitter emitting at least one laser beam to a measured object; an infrared ray transmitter emitting an infrared ray to the measured object; a laser receiver receiving the laser beam that is reflected back from the measured object; an objective lens receiving the laser beam, the infrared ray and visible light that are all reflected back from the measured object; an image sensing device receiving the infrared ray and the visible light that are captured by the objective lens and generating an image signal; a prism device disposed between the objective lens and the image sensing device and receiving the visible light, the infrared ray and the laser beam, wherein the visible light and the infrared ray are guided to the image sensing device in one direction, and the laser beam is guided to the laser receiver in another direction; and a display device displaying the image of the measured object that is captured by the image sensing device.

In another exemplary embodiment, the range finder further includes a first collimating lens disposed between the laser transmitter and the measured object.

In yet another exemplary embodiment, the laser transmitter is a semiconductor laser.

In another exemplary embodiment, the range finder further includes a second collimating lens disposed between the infrared ray transmitter and the measured object.

In yet another exemplary embodiment, the laser receiver includes an avalanche photo diode (APD).

In another exemplary embodiment, the prism device includes two triangular prisms, and the prism device is substantially rectangular.

In yet another exemplary embodiment, one of the triangular prisms includes a surface and an optical film coated on the surface to reflect the laser beam and allow passage of the infrared ray and the visible light.

In another exemplary embodiment, the surface is an inclined surface on which the optical film is coated.

In yet another exemplary embodiment, the range finder further includes a filter disposed between the prism device and the laser receiver to allow passage of the laser beam.

In another exemplary embodiment, the range finder further includes a filter disposed between the triangular prisms to reflect the laser beam and allow passage of the infrared ray and the visible light.

In yet another exemplary embodiment, the range finder further includes a filter disposed between the prism device and the laser receiver to allow passage of the laser beam.

In another exemplary embodiment, the image sensing device is preferably a charge coupled device (CCD) or a complementary metal oxide semiconductor (CMOS) device.

In yet another exemplary embodiment, the range finder further includes a focus lens disposed between the prism device and the image sensing device.

In another exemplary embodiment, the display device is preferably a liquid crystal display (LCD), an organic light emitting diode display (OLED) or an active matrix organic light emitting diode display (AMOLED) for displaying a distance of the measured object from the range finder.

In yet another exemplary embodiment, the range finder further includes an ocular lens disposed near the display device so that the display device can be observed through the ocular lens.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of the first embodiment of a range finder of the invention; and

FIG. 2 is a schematic view of the second embodiment of a range finder of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

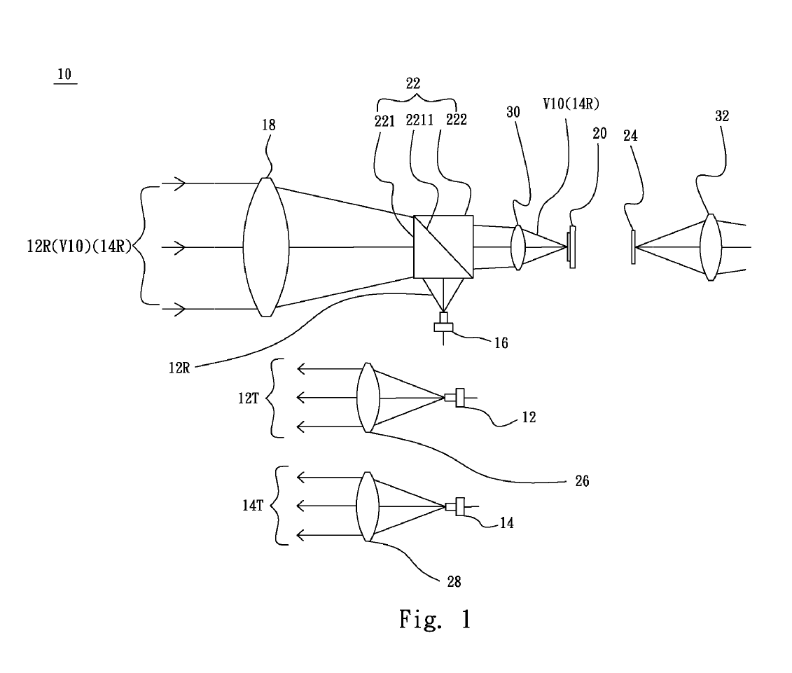

Referring to FIG. 1, a range finder 10 of a first embodiment of the invention includes a laser transmitter 12, an infrared ray transmitter 14, a laser receiver 16, an objective lens 18, an image sensing device 20, a prism device 22, a display device 24, a first collimating lens 26, a second collimating lens 28, a focus lens 30 and an ocular lens 32. The prism device 22 includes a first triangular prism 221 and a second triangular prism 222. An optical film 2211 is coated on the first triangular prism 221 or the second triangular prism 222. In this embodiment, each of the first triangular prism 221 and the second triangular prism 222 has an inclined surface, the inclined surface of the first triangular prism 221 is opposite to the inclined surface of the second triangular prism 222. The optical film 2211 is selectively coated on the inclined surface of the first triangular prism 221 or the inclined surface of the second triangular prism 222.

The laser transmitter 12, the first collimating lens 26, the objective lens 18, the prism device 22 and the laser receiver 16 constitute a laser transmitting and receiving system of the range finder 10. The objective lens 18, the prism device 22, the focus lens 30 and the image sensing device 20 constitute an image capturing system of the range finder 10. The infrared ray transmitter 14, the second collimating lens 28, the objective lens 18, the prism device 22, the focus lens 30 and the image sensing device 20 constitute a night vision system of the range finder 10. The display device 24 and the ocular lens 32 constitute a display system of the range finder 10.

When the range finder 10 is used in the daytime or an environment with sufficient light, the objective lens 18 is oriented toward a measured region (not shown), and the image captured system captures an image of the measured region. The image of the measured region is sent to the display system for user's observation, allowing the user to aim the range finder 10 at a measured object (not shown) in the measured region. The laser transmitting and receiving system emits a laser beam 12T to the measured object and receives a reflected laser beam 12R which is reflected back by the measured object. The distance of the measured object from the range finder is calculated under a subsequent data processing procedure and displayed on the display system for user's reference.

The optical path of the range finder 10 utilized in the daytime or an environment with sufficient light is described as follows. Referring to FIG. 1, when the objective lens 18 is oriented toward the measured region, visible light V10 reflected from the measured region passes through the objective lens 18 and enters the prism device 22. The prism device 22 includes the first triangular prism 221 and the second triangular prism 222. The optical film 2211 is coated on the inclined surface of the first triangular prism 221, allowing passage of the visible light and infrared ray and prohibiting passage of the laser beam. The laser beam is reflected by the optical film 2211. Therefore, the visible light V10 passes through the prism device 22 and the focus lens 30 to reach the image sensing device 20. An image formed by the visible light V10 is received by the image sensing device 20, and the received image of the measured region is converted to an image signal which is sent to the display device 24 and displayed thereon. The user observes the displayed image through the ocular lens 32 and regulates the range finder 10 to aim at the measured object in the measured region precisely.

The laser transmitter 12 emits a laser beam 12T which passes through the first collimating lens 26 to become a collimated laser beam 12T. The collimated laser beam 12T is reflected by the measured object, and the reflected laser beam 12R travels back to the range finder 10. The laser beam 12R passes through the objective lens 18 to enter the prism device 22. The prism device 22 includes the first triangular prism 221 and the second triangular prism 222. The optical film 2211 is coated on the inclined surface of the first triangular prism 221, allowing passage of the visible light and infrared light and prohibiting passage of the laser beam 12R. The laser beam 12R is reflected by the optical film 2211 to the laser receiver 16. The distance of the measured object is calculated under a subsequent data processing procedure and displayed on the display device 24, whereby a user can read the distance value through the ocular lens 32.

At night or in an environment with insufficient light, the image capturing system is unable to catch the image of the measured region. No image or a very dark image of the measured region can be observed through the display device 24, and thus most of the conventional range finders are unable or only roughly to be aimed at the measured object. The range finder 10 of the invention has the night vision system which is able to catch the infrared image of the measured region and facilitates aim of the range finder 10 at the measured object. In the invention, when the objective lens 18 is oriented toward the measured region, the infrared image of the measured region is captured by the night vision system. The captured infrared image is sent to the display device for user's observation, allowing the user to aim the range finder 10 at the measured object. The laser transmitting and receiving system emits a laser beam 12T to the measured object and receives a laser beam 12R reflected by the measured object. The distance of the measured object from the range finder 10 is calculated under a subsequent data processing procedure and sent to the display device for user's reference.

The optical path of the range finder 10 used at night or in the environment with insufficient light is described as follows. Referring to FIG. 1, when the objective lens 18 is oriented toward the measured region, the infrared ray transmitter 14 emits an infrared ray 14T which passes through the second collimating lens 28 to become a collimated infrared ray 14T. The collimated infrared ray 14T is directed to the measured object and reflected by the measured object. The reflected infrared ray 14R travels to the range finder 10 and passes through the objective lens 18 to enter the prism device 22. The prism device 22 includes the first triangular prism 221 and the second triangular prism 222. An optical film 2211 is coated on the inclined surface of the first triangular prism 221. The optical film 2211 allows passage of the visible light and infrared ray and prohibits passage of the laser beam. The laser beam is reflected by the optical film 2211. The incident infrared ray 14R passes through the optical film 2211 and the focus lens 30 to reach the image sensing device 20. The image sensing device 20 receives the infrared ray 14R from the measured region. The infrared image of the measured region is converted to an image signal which is sent to the display device 24. The ocular lens 32 is located beside the display device 24, for the user to observe the infrared image of the measured region displayed by the display device 24 and correctly aim the range finder 10 at the measured object in the measured region.

The laser transmitter 12 emits a laser beam 12T which passes through the first collimating lens 26 to become a collimated laser beam 12T. The collimated laser beam 12T is directed to the measured object and reflected by the measured object. The reflected laser beam 12R travels to the range finder 10 and passes through the objective lens 18 to enter the prism device 22. The prism device 22 includes the first triangular prism 221 and the second triangular prism 222. The optical film 2211 is coated on the inclined surface of the first triangular prism 221 to allow passage of the visible light and infrared light and prohibit passage of the laser beam. The laser beam 12R is reflected by the optical film 2211 and directed to the laser receiver 16 which receives the laser beam 12R. The distance of the measured object from the range finder is calculated under a subsequent data processing procedure and displayed on the display device 24, whereby a user can read the displayed distance value through the ocular lens 32.

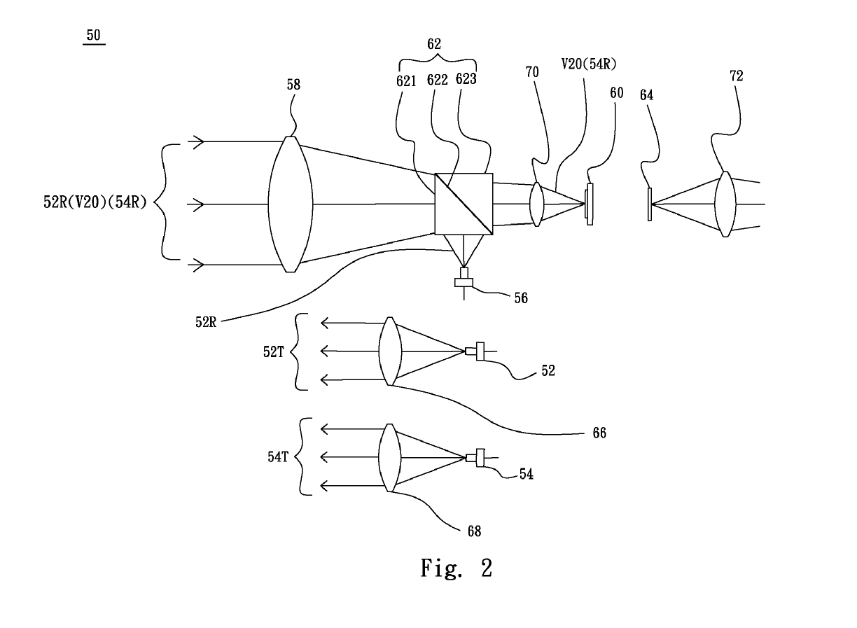

Referring to FIG. 2, a range finder 50 of a second embodiment of the invention includes a laser transmitter 52, an infrared ray transmitter 54, a laser receiver 56, an objective lens 58, an image sensing device 60, a prism device 62, a display device 64, a first collimating lens 66, a second collimating lens 68, a focus lens 70 and ocular lens 72. The prism device 62 includes a first triangular prism 621, a filter 622 and a second triangular prism 623. The filter 622 is disposed between the first triangular prism 621 and the second triangular prism 623. The filter 622 allows passage of the visible light and infrared ray and prohibits passage of the laser beam. The laser beam is reflected by the filter 622 which functions similar to the optical film 2211 in the first embodiment.

The optical path and utilization of the second embodiment are similar to those of the first embodiment in the daytime, in the environment with sufficient light, at night, and in the environment with insufficient light. Thus, the descriptions thereof are omitted.

The laser transmitters 12 and 52 are preferably a semiconductor laser, and the laser receivers 16 and 56 are preferably an avalanche photo diode (APD). The image sensing devices 20 and 60 are preferably a charge coupled device (CCD) or a complementary metal oxide semiconductor (CMOS) device. The display devices 24 and 64 are preferably a liquid crystal display (LCD), an organic light emitting diode display (OLED) or an active matrix organic light emitting diode display (AMOLED).

Although the reflected laser beams 12R and 52R directly enter the laser receiver 16 and 56 in the described embodiments, the invention is not limited thereto. A range finder including a filter disposed between the prism device 22, 62 and the laser receiver 16, 56, which only allows passage of a laser beam, also belongs to the category of the invention.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A range finder, comprising:
a laser transmitter emitting at least one laser beam to a measured object;
an infrared ray transmitter emitting an infrared ray to the measured object;
a laser receiver receiving the laser beam that is reflected back from the measured object;
an objective lens receiving visible light, the laser beam, and the infrared ray that are all reflected back from the measured object;
an image sensing device receiving the infrared ray and the visible light that are captured by the objective lens and generating an image signal;
a prism device disposed between the objective lens and the image sensing device and receiving the visible light, the infrared ray and the laser beam, wherein the visible light and the infrared ray are guided to the image sensing device in one direction, and the laser beam is guided to the laser receiver in another direction; and
a display device displaying the image of the measured object that is captured by the image sensing device.

2. The range finder as claimed in claim 1 further comprising a first collimating lens disposed between the laser transmitter and the measured object.

3. The range finder as claimed in claim 1 further comprising a second collimating lens disposed between the infrared ray transmitter and the measured object.

4. The range finder as claimed in claim 1, wherein the prism device comprises two triangular prisms.

5. The range finder as claimed in claim 4, wherein one of the triangular prisms comprises a surface and an optical film coated on the surface to reflect the laser beam and allow passage of the infrared ray and the visible light.

6. The range finder as claimed in claim 5 further comprising a filter disposed between the prism device and the laser receiver to allow passage of the laser beam.

7. The range finder as claimed in claim 4 further comprising a filter disposed between the triangular prisms to reflect the laser beam and allow passage of the infrared ray and the visible light.

8. The range finder as claimed in claim 7 further comprising a filter disposed between the prism device and the laser receiver to allow passage of the laser beam.

9. The range finder as claimed in claim 1 further comprising a focus lens disposed between the prism device and the image sensing device.

10. The range finder as claimed in claim 1 further comprising an ocular lens disposed near the display device so that the display device can be observed through the ocular lens.

11. The range finder as claimed in claim 1, wherein the display device is configured to display a distance of the measured object from the ranger finder.

12. The range finder as claimed in claim 4, wherein the prism device is substantially rectangular.

13. The range finder as claimed in claim 5, wherein the surface is an inclined surface, on which the optical film is coated.
